(19) United States
(12) Patent Application Publication
(10) Pub. No.: US 2025/0015615 A1
(43) Pub. Date: Jan. 9, 2025

(54) POWER SUPPLY SYSTEM, NOTIFICATION METHOD, AND STORAGE MEDIUM

(71) Applicant: CASIO COMPUTER CO., LTD., Tokyo (JP)

(72) Inventors: Hirokazu HASEGAWA, Tokyo (JP); Kazuto YAMAMOTO, Tokyo (JP); Masanobu SATOU, Tokyo (JP); Erina ICHIKAWA, Tokyo (JP); Kouki MAYUZUMI, Tokyo (JP)

(73) Assignee: CASIO COMPUTER CO., LTD., Tokyo (JP)

(21) Appl. No.: 18/732,815

(22) Filed: Jun. 4, 2024

(30) Foreign Application Priority Data
Jul. 6, 2023 (JP) 2023-111352

(51) Int. Cl. H02J 7/00; H02J 50/10; H02J 50/80

(52) U.S. Cl. CPC H02J 7/0031; H02J 7/00309; H02J 7/0047; H02J 50/10; H02J 50/80

(57) ABSTRACT

A power supply system includes: an indicator lamp; and at least one processor. The at least one processor executes retry processing of stopping and then restarting non-contact power supply in a case where an error occurs during the non-contact power supply performed on a robot. The at least one processor maintains a display manner of the indicator lamp during execution of the retry processing as a first manner same as a manner when the error does not occur, in a case where a state of the non-contact power supply is notified by a display manner of the indicator lamp and the occurring error corresponds to an error of a first classification.

### CROSS-REFERENCE TO RELATED APPLICATIONS

This application is based upon and claims the benefit of priority under 35 USC 119 of Japanese Patent Application No. 2023-111352, filed on Jul. 6, 2023, the entire disclosure of which, including the description, claims, drawings, and abstract, is incorporated herein by reference in its entirety.

### FIELD OF THE INVENTION

The present disclosure relates generally to a power supply system, a notification method, and a storage medium.

### BACKGROUND OF THE INVENTION

A technique for providing notification to a user when some sort of error occurs during operation of a device is known. For example, Unexamined Japanese Utility Model Application Publication No. H03-110609 discloses a technique for displaying a fact that retry is being executed during the retry for attempting a reading or writing action of a hard disc in a hard disc driving device, and displaying a warning when a time of the retry is longer than a predetermined time.

### SUMMARY OF THE INVENTION

A power supply system according to one example of the present disclosure includes:
an indicator lamp; and
at least one processor,
wherein the at least one processor
executes retry processing of stopping and then restarting non-contact power supply in a case where an error occurs during the non-contact power supply performed on a robot, and
maintains a display manner of the indicator lamp during execution of the retry processing as a first manner same as a manner when the error does not occur, in a case where a state of the non-contact power supply is notified by a display manner of the indicator lamp and the occurring error corresponds to an error of a first classification.

### BRIEF DESCRIPTION OF DRAWINGS

A more complete understanding of this application can be obtained when the following detailed description is considered in conjunction with the following drawings, in which:

FIG. 1 is a drawing illustrating an overview of an entire configuration of a power supply system according to Embodiment 1;

FIG. 2 is a cross-sectional view of a robot according to Embodiment 1, viewed from a side surface;

FIG. 3 is a drawing illustrating a housing of the robot according to Embodiment 1;

FIG. 4 is a drawing illustrating a state where power is supplied from a power supply device to the robot according to Embodiment 1;

FIG. 5 is a block diagram illustrating a hardware configuration of the power supply device and the robot according to Embodiment 1;

FIG. 6 is a block diagram illustrating a configuration of a control module in the power supply apparatus according to Embodiment 1;

FIG. 7 is a drawing illustrating an example of a notification table according to Embodiment 1;

FIG. 8 is a flowchart illustrating a flow of power supply processing executed by the power supply device according to Embodiment 1;

FIG. 9 is a flowchart illustrating a flow of notification processing executed by the power supply device according to Embodiment 1;

FIG. 10 is a flowchart illustrating a flow of retry processing executed by the power supply device according to Embodiment 1;

FIG. 11 is a drawing illustrating an overview of an entire configuration of a power supply system according to Embodiment 2; and

FIG. 12 is a block diagram illustrating a configuration of a notification device according to Embodiment 2.

### DETAILED DESCRIPTION OF THE INVENTION

Hereinafter, embodiments of the present disclosure are described while referencing the drawings. Note that, in the drawings, identical or corresponding components are denoted with the same reference numerals.

### Embodiment 1

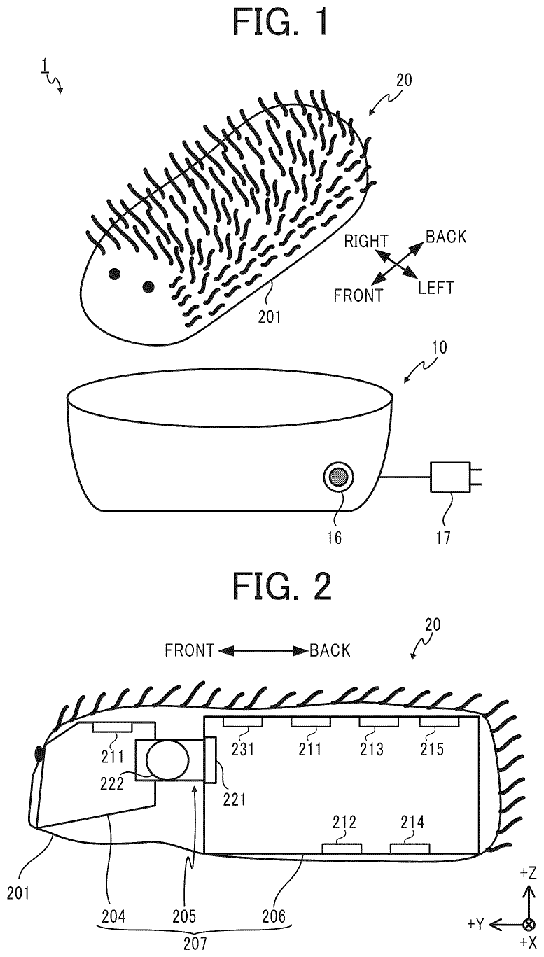

FIG. 1 schematically illustrates a configuration of a power supply system 1 according to Embodiment 1. The power supply system 1 includes a power supply device 10 and a robot 20. The power supply system 1 is a system for supplying power from the power supply device 10 to the robot 20 by non-contact power supply. The non-contact power supply is also called wireless power supply, and is a technique for supplying power from a device on a power supply side to a device on a power reception side without interposing connection of a cable, contact of a metal electrode, and the like.

The robot 20 is a device that autonomously executes an action without depending on a direct operation by a user. The robot 20 is a pet robot that resembles a small animal. The robot 20 includes an exterior 201 provided with bushy fur and decorative parts resembling eyes.

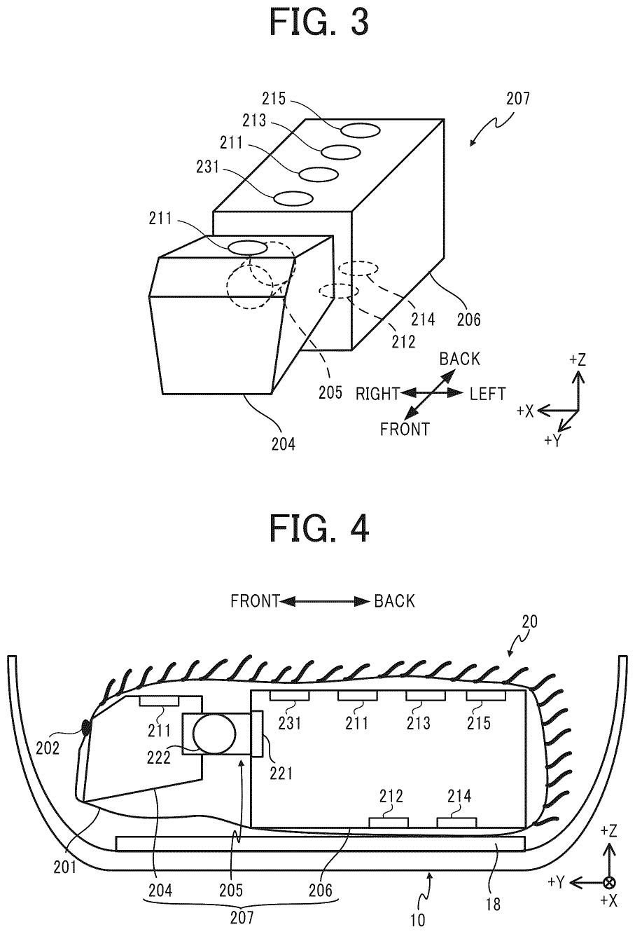

As illustrated in FIGS. 2 and 3, the robot 20 includes a housing 207. The housing 207 is covered with the exterior 201 and is accommodated in the exterior 201. The housing 207 includes a head 204, a coupler 205, and a torso 206. The coupler 205 couples the head 204 and the torso 206.

The exterior 201 is one example of an exterior member, and has a bag shape that is long in a front-back direction and can accommodate the housing 207 in the exterior 201. The exterior 201 has a cylindrical shape from the head 204 to the torso 206, and integrally covers the torso 206 and the head 204. The exterior 201 has such a shape, and thus the robot 20 has a shape that lies on a stomach.

An outer material of the exterior 201 is made of artificial pile weave resembling fur of a small animal in order to resemble a texture of a small animal. A lining material of the exterior 201 is made of synthetic fiber, natural fiber, natural leather, artificial leather, a sheet material of synthetic resin, a sheet material of rubber, and the like. The exterior 201 is made of such a material having flexibility, and thus follows a movement of the housing 207. Specifically, the exterior 201 follows a rotation of the head 204 with respect to the torso 206.

The torso 206 extends in the front-back direction, and is in contact with a placement surface of a floor, a table, or the like where the robot 20 is placed via the exterior 201. The torso 206 includes a twist motor 221 on a front end of the torso 206. The head 204 is coupled to the front end of the torso 206 via the coupler 205. The coupler 205 includes a vertical motor 222. Note that, in FIG. 2, the twist motor 221 is provided on the torso 206, but may be provided on the coupler 205. The head 204 is rotatably coupled to the torso 206 with a left-right direction and the front-back direction of the robot 20 as axes by the twist motor 221 and the vertical motor 222.

Note that, as coordinate axes of XYZ, an X-axis and a Y-axis are set in a horizontal plane, and a Z-axis is set in a vertical direction. A+ direction of the Z-axis corresponds to a vertically upward direction. Then, in order to facilitate comprehension below, it is described that the robot 20 is placed on a placement surface in the left-right direction (width direction) of the robot 20 as an X-axis direction and the front-back direction of the robot 20 as a Y-axis direction.

The coupler 205 couples the torso 206 and the head 204 so as to enable rotation around a first rotational axis that passes through the coupler 205 and extends in the front-back direction (Y direction) of the torso 206. The twist motor 221 rotates the head 204, with respect to the torso 206, clockwise (right rotation) within a forward rotation angle range (forward rotation), counterclockwise (left rotation) within a reverse rotation angle range (reverse rotation), and the like.

Further, the coupler 205 couples the torso 206 and the head 204 so as to enable rotation around a second rotational axis that passes through the coupler 205 and extends in the left-right direction (width direction, X direction) of the torso 206. The vertical motor 222 rotates the head 204 upward (forward rotation) within a forward rotation angle range, downward (reverse rotation) within a reverse rotation angle range, and the like.

As illustrated in FIGS. 2 and 3, the robot 20 includes a touch sensor 211 on the head 204 and the torso 206. The robot 20 can detect, by the touch sensor 211, petting or striking of the head 204 or the torso 206 by the user.

The robot 20 includes an acceleration sensor 212, a microphone 213, a gyrosensor 214, an illumination sensor 215, and a speaker 231 on the torso 206. The robot 20 can detect a change in an attitude of the robot 20 itself by the acceleration sensor 212 and the gyrosensor 214, and can detect being picked up, an orientation being changed, being thrown, and the like by the user. The robot 20 can detect illumination around the robot 20 by the illumination sensor 215. The robot 20 can detect external sounds by the microphone 213. The robot 20 can emit an animal sound from the speaker 231.

Note that at least a portion of the acceleration sensor 212, the microphone 213, the gyrosensor 214, the illumination sensor 215, and the speaker 231 may be provided on the head 204 instead of the torso 206, or may be provided on both of the torso 206 and the head 204.

Returning to FIG. 1, the power supply device 10 is a device for supplying power to the robot 20 by the non-contact power supply (wireless power supply). The power supply device 10 functions as a charging station for charging the robot 20. The power supply device 10 includes a notifier 16 outside a side wall. The power supply device 10 receives power supply from a commercial power source via an alternate current (AC) adapter 17.

The power supply device 10 is installed at an appropriate place where the robot 20 can autonomously move to the power supply device 10. The robot 20 moves to the power supply device 10 for charging a battery when a charge amount of the battery is equal to or less than a lower limit value or when a predetermined timing comes.

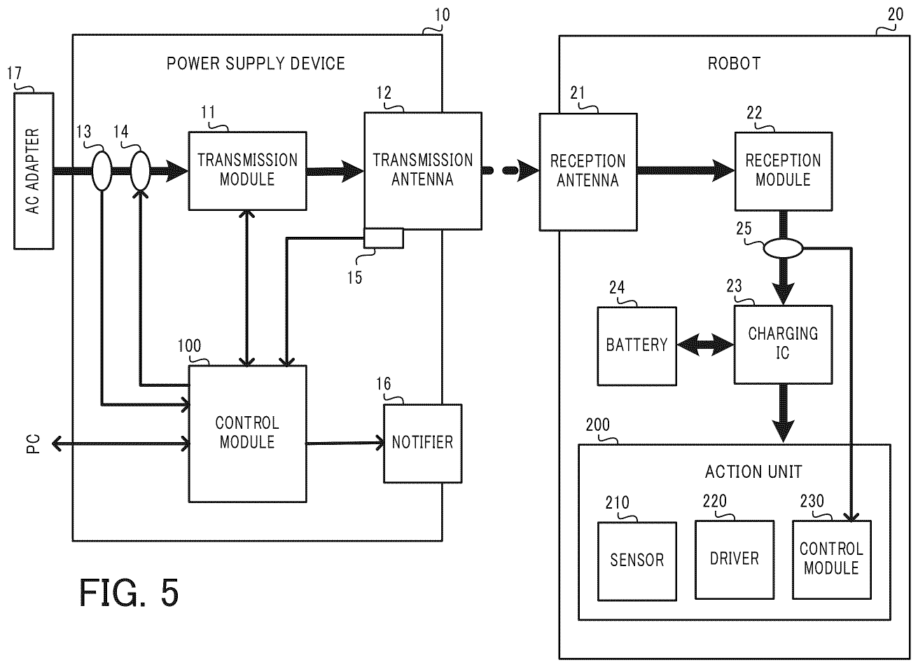

As illustrated in FIG. 4, the power supply device 10 includes a pedestal 18 being a placement portion for placing the robot 20. The power supply device 10 has a bowl shape surrounding the robot 20 by the side wall in a state where the robot 20 is placed on the pedestal 18.

A power transmission coil is provided in the pedestal 18. The power supply device 10 can charge a battery in a wireless manner by using a known method such as electromagnetic induction, magnetic field resonance, and electric field coupling in the state where the robot 20 is placed on the pedestal 18. Hereinafter, a description is given with the method of electromagnetic induction as an example.

As illustrated in FIG. 5, the power supply device 10 includes a transmission module 11, a transmission antenna 12, a current sensor 13, a switch 14, a thermistor 15, a notifier 16, and a control module 100.

The transmission module 11 receives power supplied from the AC adapter 17 and supplies power to the transmission antenna 12. The transmission module 11 includes a conversion circuit that converts power supplied from the AC adapter 17 into power to be supplied to the transmission antenna 12, and the like. The conversion circuit raises a voltage value of power supplied from the AC adapter 17 to a predetermined voltage value, and converts the power into an alternating current at a predetermined frequency. The transmission module 11 supplies the alternating current converted by the conversion circuit to the transmission antenna 12.

The transmission antenna 12 includes a power transmission coil for transmitting power to the robot 20. The power transmission coil is acquired by winding a lead wire in a spiral in the pedestal 18. In the transmission antenna 12, alternating-current power supplied from the transmission module 11 flows through the power transmission coil, and thus an induced magnetic flux is generated. The transmission antenna 12 transmits power to the robot 20 by the induced magnetic flux generated in the power transmission coil.

Note that the transmission module 11 and the transmission antenna 12 are collectively referred to as a “power supplier”. The power supplier is one example of power supply means for performing non-contact power supply on the robot 20.

The current sensor 13 is installed between the AC adapter 17 and the transmission module 11, and measures a current flowing between the AC adapter 17 and the transmission module 11. The current sensor 13 supplies a value of the measured current to the control module 100.

The switch 14 includes, for example, a field effect transistor (FET). The switch 14 switches between supply and cutoff (ON and OFF) of power supplied from the AC adapter 17 to the transmission module 11 according to a switch signal transmitted from the control module 100.

The thermistor 15 is installed on the transmission antenna 12, and measures a temperature of the transmission antenna 12. The thermistor 15 supplies the measured temperature to the control module 100.

The notifier 16 is one example of notification means for providing notification according to a state of the power supply device 10. Specifically, the notifier 16 includes light emitting diodes (LEDs) of three colors of red, green, and blue being indicator lamps. The notifier 16 notifies a user of a current state of the power supply device 10 by lighting each of the LEDs of three colors in various patterns. As illustrated in FIG. 1, the notifier 16 is installed outside the side wall of the power supply device 10, which is a position easy for the user to confirm.

Returning to FIG. 5, the robot 20 includes a reception antenna 21, a reception module 22, a charging integrated circuit (IC) 23, a battery 24, a voltage sensor 25, and an action unit 200.

The reception antenna 21 receives power supplied from the power supply device 10. The reception antenna 21 includes a power reception coil that receives power transmitted from the transmission antenna 12. The power reception coil is wound in a position facing the power transmission coil of the transmission antenna 12 in the state where the robot 20 is located on the pedestal 18. In the power reception coil, electromotive force is induced in response to a change in an induced magnetic flux generated in the power transmission coil of the transmission antenna 12. The reception antenna 21 supplies the electromotive force induced in the power reception coil to the reception module 22.

The reception module 22 receives power supplied from the reception antenna 21 and supplies the power to the charging IC 23. The reception module 22 includes a conversion circuit that converts alternating-current power supplied from the reception antenna 21 into direct-current power, and the like. The conversion circuit rectifies electromotive force induced in the power reception coil of the reception antenna 21, generates direct-current power, and supplies the direct-current power to the charging IC 23.

Note that the reception antenna 21 and the reception module 22 are collectively referred to as a “power receiver”. The power receiver is one example of power reception means for receiving power supplied from the power supply device 10.

The charging IC 23 controls charging and discharging in the battery 24. The battery 24 is a chargeable secondary battery, and stores power to be used in the robot 20. When the charging IC 23 is supplied with power from the reception module 22, the charging IC 23 charges the battery 24 with the supplied power. Further, when the action unit 200 needs power, the charging IC 23 discharges power stored in the battery 24, and supplies the power to the action unit 200.

The voltage sensor 25 is installed between the reception module 22 and the charging IC 23, and measures an output voltage from the reception module 22 to the charging IC 23. Whether the battery 24 is being charged can be determined by a measurement result of the voltage sensor 25.

The action unit 200 is a unit for causing the robot 20 to perform an action. The action unit 200 includes a sensor 210, a driver 220, and a control module 230.

The sensor 210 includes the touch sensor 211, the acceleration sensor 212, the microphone 213, the gyrosensor 214, and the illumination sensor 215 described above. The controller 110 acquires, as an external stimulus via a bus line, a detection value detected by various sensors of the sensor 210.

The driver 220 includes the twist motor 221 and the vertical motor 222, and is driven by the controller 110. The twist motor 221 is a servomotor for rotating the head 204 with respect to the torso 206 in the left-right direction (width direction) with the front-back direction as an axis. The vertical motor 222 is a servomotor for rotating the head 204 with respect to the torso 206 in an up-down direction (height direction) with the left-right direction as an axis. The robot 20 can express an action twisting the head 204 sideways by the twist motor 221, and can express an action raising and lowering the head 204 by the vertical motor 222.

The control module 230 comprehensively controls the entire robot 20. Although not illustrated, the control module 230 includes a controller such as a central processing unit (CPU), a storage such as a read only memory (ROM), a random access memory (RAM), and a flash memory, and a communicator for communicating with an external apparatus.

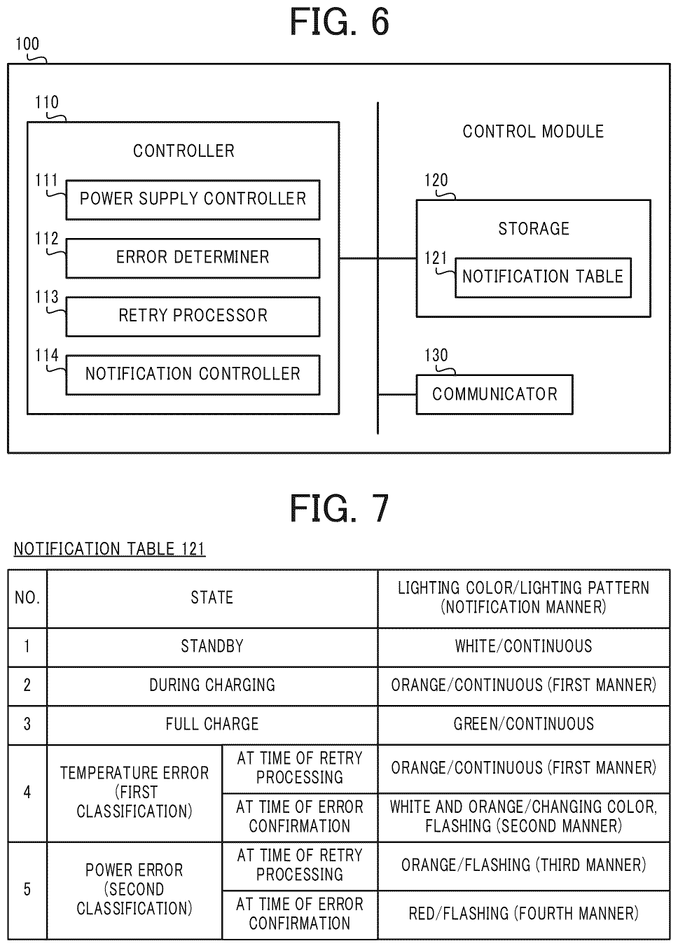

Next, a configuration of the control module 100 of the power supply device 10 is described with reference to FIG. 6. The control module 100 includes a controller 110, a storage 120, and a communicator 130.

The controller 110 includes a CPU. The CPU is, for example, a microprocessor and the like, and is a central processing unit that executes various types of processing and operations. In the controller 110, the CPU controls actions of the entire power supply device 10 by reading a control program stored in a ROM and using a RAM as a work memory. The controller 110 may be called a “processor”.

The storage 120 includes the ROM, the RAM, a flash memory, and the like. The storage 120 stores a program and data that include an operating system (OS) and an application program and are used for the controller 110 to execute various types of processing. Further, the storage 120 stores data generated or acquired by executing various types of processing by the controller 110. For example, the storage 120 stores a notification table 121.

The communicator 130 includes a communication interface for communicating with an external apparatus of the power supply device 10. For example, the communicator 130 communicates with an external apparatus such as the robot 20 and a personal computer (PC) according to known communication standards such as a local area network (LAN) and a universal serial bus (USB). Further, the communicator 130 may communicate with the robot 20 via short-range wireless communication such as near field communication (NFC) and Bluetooth (registered trademark).

Next, a functional configuration of the controller 110 is described. As illustrated in FIG. 6, the controller 110 functionally includes a power supply controller 111 being one example of power supply control means, an error determiner 112 being one example of error determination means, a retry processor 113 being one example of retry processing means, and a notification controller 114 being one example of notification control means. In the controller 110, the CPU functions as each of the components by reading a program stored in the ROM into the RAM, executing the program, and controlling the program.

The power supply controller 111 controls power supply from the power supply device 10 to the robot 20. The power supply controller 111 transmits a switch signal between ON and OFF to the switch 14, and switches between supply and cutoff of power from the AC adapter 17 to the power supplier (the transmission module 11 and the transmission antenna 12).

Specifically, when the power supply controller 111 detects that the robot 20 moves to above the pedestal 18, the power supply controller 111 transmits an ON signal to the switch 14, and starts supply of power to the transmission module 11. Further, when the power supply controller 111 detects that the robot 20 moves away from above the pedestal 18 or when the battery 24 of the robot 20 reaches a full charge, the power supply controller 111 transmits an OFF signal to the switch 14, and stops supply of power to the transmission module 11.

The power supply controller 111 communicates with the robot 20 via the communicator 130, and thus detects whether the robot 20 is located on the pedestal 18 and whether the battery 24 has reached a full charge. For example, the power supply controller 111 communicates with the robot 20 via appropriate wireless communication such as a LAN, Bluetooth (registered trademark), and an NFC. In the robot 20, when the robot 20 moves to above the pedestal 18, the control module 230 notifies the power supply device 10 that the robot 20 has moved to above the pedestal 18 via wireless communication. The same also applies when the robot 20 moves away from above the pedestal 18 and when the battery 24 has reached a full charge.

The error determiner 112 determines whether an error related to non-contact power supply occurs during the non-contact power supply performed by the power supplier. The error related to the non-contact power supply is an error that has a possibility of occurring during the non-contact power supply and prevents normal non-contact power supply. Specifically, as the error related to the non-contact power supply, there are (1) a temperature error being one example of an error of a first classification, and (B) a power error being one example of an error of a second classification.

(A) The temperature error is an error related to a temperature in the power supply device 10. The temperature error is detected by the thermistor 15 installed on the transmission antenna 12.

Specifically, the error determiner 112 acquires a temperature measured by the thermistor 15 installed on the transmission antenna 12, and determines whether the acquired temperature falls within an appropriate range. When the acquired temperature does not fall within the appropriate range as a result of the determination, the error determiner 112 determines that an error related to a temperature occurs.

Herein, the appropriate range is preset as a range of temperature at which normal non-contact power supply can be achieved. Specifically, it is difficult to normally perform the non-contact power supply when a temperature of the power supply device 10 is too high, the appropriate range is set as a range equal to or less than an upper limit temperature (for example, 70° C.). Note that it is also difficult to normally perform the non-contact power supply when a temperature of the power supply device 10 is too low, a condition of being equal to or more than a lower limit temperature in addition to being equal to or less than the upper limit temperature may be set to the appropriate range.

The temperature error may be naturally solved with a lapse of time as a temperature in the power supply device 10 changes from a high temperature or a low temperature into an appropriate temperature range. On the other hand, the temperature error may not be naturally solved depending on a cause of the temperature error, and may need to be handled by a user.

(B) The power error is an error related to power transmitted and received between the power supply device 10 and the robot 20. The power error is an error when there is a great difference between transmission power being transmitted to the robot 20 and reception power being received by the robot 20 during the non-contact power supply performed by the power supplier. The power error is detected based on a difference between transmission power and reception power.

Specifically, the error determiner 112 acquires a value of a current measured by the current sensor 13, and derives magnitude of transmission power being transmitted from the power supply device 10 to the robot 20, based on the acquired value of the current. Further, the error determiner 112 acquires a value of a voltage measured by the voltage sensor 25 of the robot 20 by communicating with the robot 20 via the communicator 130. Then, the error determiner 112 derives magnitude of reception power being received by the robot 20, based on the acquired value of the voltage. The error determiner 112 compares magnitude of the derived transmission power and magnitude of the derived reception power, and, when a difference is greater than a predetermined threshold value, the error determiner 112 determines that an error related to the transmission/reception power occurs.

Herein, the threshold value is set as a value in which presence of a significant difference in magnitude between transmission power and reception power can be determined as compared to when the non-contact power supply is normally performed. More specifically, even when the non-contact power supply is normally performed, a power loss occurs due to a leakage flux generated between the transmission antenna 12 and the reception antenna 21. Thus, a difference to some extent is generated between transmission power and reception power. In consideration of such a power loss, the threshold value is set as a value in which presence of a significant difference in magnitude between transmission power and reception power can be determined.

As a cause of the power error, there are (B1) a position deviation of the robot 20, (B2) presence of foreign matter, and (B3) occurrence of an overcurrent or an overvoltage.

(B1) A position deviation of the robot 20 means a deviation of the robot 20 from an appropriate power supply position above the pedestal 18 of the power supply device 10. When a position deviation occurs, the transmission antenna 12 and the reception antenna 21 do not face each other, and thus a power loss increases.

For example, the robot 20 moves the head 204 with respect to the torso 206 and emits an animal sound from the speaker 231 even during the non-contact power supply in the power supply device 10 in order to enhance a sense of lifelikeness. In this way, when the robot 20 moves during the non-contact power supply, a position of the robot 20 may deviate from an appropriate power supply position.

When a cause of the power error is a position deviation of the robot 20, the power error is solved by placing the robot 20 in an appropriate power supply position again by a user. Further, a position deviation may be spontaneously solved by the robot 20 moving on the pedestal 18.

(B2) Presence of foreign matter means presence of some sort of foreign matter between the transmission antenna 12 and the reception antenna 21. For example, when foreign matter is caught between the robot 20 and the pedestal 18, a position of the robot 20 deviates. Further, when foreign matter of metal such as a coin and a metal piece is present, an induced magnetic flux generated in the transmission antenna 12 is affected. The foreign matter leads to an increase in a power loss between transmission power and reception power.

When a cause of the power error is presence of foreign matter, the power error is solved by removing the foreign matter by a user while the non-contact power supply is stopped.

(B3) Occurrence of an overcurrent or an overvoltage means occurrence of an abnormal current or an abnormal voltage in the power supply device 10 or the robot 20 due to some sort of cause. (B2) Presence of foreign matter described above may be a cause of an overcurrent or an overvoltage. Further, an overcurrent or an overvoltage may also occur due to the other cause.

When a cause of the power error is an overcurrent or an overvoltage, such an error is an error having high importance, and thus a user needs to take action by asking a support center, and the like.

The retry processor 113 executes retry processing when the error determiner 112 determines that an error related to the non-contact power supply occurs during the non-contact power supply performed by the power supplier. Herein, the retry processing is processing of temporarily stopping the non-contact power supply and attempting to solve the error.

Specifically, the retry processing includes processing of stopping the non-contact power supply, and restarting the non-contact power supply after waiting for only a predetermined waiting time. The waiting time is a time preset as a time required to solve an error, and is a time of, for example, about a few seconds to a few tens of seconds.

For example, when the temperature error occurs, a temperature inside the power supply device 10 may fall within an appropriate range with a lapse of time. Alternatively, when the power error occurs due to a position deviation of the robot 20, the power error may be solved by a user correcting the position deviation or by the robot 20 spontaneously moving. Further, when the power error occurs due to presence of foreign matter, the power error may be solved by a user removing the foreign matter. The waiting time is a time needed to solve such an error.

As the retry processing, the retry processor 113 executes processing of stopping the non-contact power supply, waiting for only a predetermined waiting time, restarting the non-contact power supply, and determining whether an error is solved. When the error is not solved by such retry processing, the retry processor 113 repeatedly executes the retry processing for a predetermined number of times. The predetermined number of times is an upper limit number of times of the retry processing, and is preset to at least once (for example, three times). When an error is not solved after the retry processing is executed for the predetermined number of times, the error is determined as an error that is not easily solved, and thus the retry processor 113 does not execute the retry processing from that point on.

The notification controller 114 provides notification according to a state of the power supply device 10. The notification controller 114 transmits a control signal to the notifier 16, and lights the LED of the notifier 16 in a color and a pattern corresponding to a state of the power supply device 10. In this way, the notification controller 114 can make it easy for a user to confirm a current state of the power supply device 10.

The notification controller 114 refers to the notification table 121 stored in the storage 120. As illustrated in FIG. 7, the notification table 121 determines a lighting color and a lighting pattern of the LED of the notifier 16 as a notification manner for each state of the power supply device 10. Hereinafter, with reference to FIG. 7, notification manners in five states of (1) “standby”, (2) “during charging”, (3) “full charge”, (4) “temperature error”, and (5) “power error” are described.

(1) “Standby” in the notification table 121 corresponds to a waiting state where the power supply device 10 does not perform the non-contact power supply. For example, standby corresponds to a state where the robot 20 is not located on the pedestal 18 being a power supply position. When a state of the power supply device 10 corresponds to the standby, the notification controller 114 continuously lights the LED of the notifier 16 in white.

(2) “During charging” in the notification table 121 corresponds to a state during the non-contact power supply performed on the robot 20 located on the pedestal 18 being the power supply position. When a state of the power supply device 10 corresponds to the state during charging, the notification controller 114 continuously lights the LED of the notifier 16 in orange. A notification manner at this time is referred to as a “first manner”. In this way, when an error does not occur during the non-contact power supply performed by the power supplier, the notification controller 114 provides notification in the first manner indicating that power supply is normal.

(3) “Full charge” in the notification table 121 corresponds to a state where the battery 24 of the robot 20 is fully charged. For example, a full charge corresponds to a state where a charging amount of the battery 24 is equal to or more than a predetermined threshold value (for example, 90% of a maximum charging amount of the battery 24). When a state of the power supply device 10 corresponds to the full charge, the notification controller 114 continuously lights the LED of the notifier 16 in green.

(4) “Temperature error” in the notification table 121 corresponds to a state where the temperature error occurs during the non-contact power supply performed on the robot 20 in the power supply device 10. When a state of the power supply device 10 corresponds to the temperature error, the notification controller 114 provides notification in notification manners different between “at time of retry processing” and “at time of error confirmation”.

Herein, “at time of retry processing” is a timing at which the retry processor 113 executes the retry processing when an error occurs during the non-contact power supply performed by the power supplier. More specifically, “at time of retry processing” corresponds to a period from a start of the retry processing until an error is solved, or a period from a start of the retry processing until the number of execution times of the retry processing reaches a predetermined number of times. In contrast, “at time of error confirmation” is a case where the temperature error is not solved even when the retry processor 113 executes the retry processing. More specifically, “at time of error confirmation” corresponds to a case where an error is not solved even when the retry processing is repeated for a predetermined number of times.

When an error occurs during the non-contact power supply performed by the power supplier and the occurring error corresponds to the temperature error, the notification controller 114 provides notification in the first manner at time of the retry processing and provides notification in a second manner different from the first manner at time of error confirmation. Specifically, when the error determiner 112 determines that the temperature error occurs, the notification controller 114 continuously lights the LED of the notifier 16 in orange at time of the retry processing, and flashes the LED of the notifier 16 while changing a color alternately between white and orange at time of error confirmation.

In this way, the notification controller 114 provides notification in the first manner same as the notification manner of (2) “during charging” described above at time of the retry processing for the temperature error. That is to say, when the temperature error occurs during the non-contact power supply performed on the robot 20 by the power supplier, the notification controller 114 does not change a notification manner before and after the temperature error occurs during the retry processing. In other words, even when the temperature error occurs, the notification controller 114 does not immediately notify a user of the occurrence.

The reason why the temperature error is not immediately notified to the user in such a manner is that the temperature error has a possibility of being naturally solved with a lapse of time without requiring action by the user. Even if notification is provided to the user in such a case, time and effort of the user go to waste instead. Thus, the notification controller 114 does not change a notification manner before and after the temperature error occurs during the retry processing, and provides notification in the first manner in both of the cases.

When the temperature error is solved by the retry processing, the notification controller 114 provides notification in the first manner subsequently to the time of the retry processing. On the other hand, when the temperature error is not solved by the retry processing, there is a high possibility that the user needs to take action in order to solve the temperature error. Thus, when the temperature error is not solved by the retry processing, the notification controller 114 switches the second manner being the notification manner different from that before the temperature error occurs, and provides notification.

(5) “Power error” in the notification table 121 corresponds to a state where the power error occurs during the non-contact power supply performed on the robot 20 in the power supply device 10. When a state of the power supply device 10 corresponds to the power error, the notification controller 114 provides notification in notification manners different between “at time of retry processing” and “at time of error confirmation”, similarly to the case of “temperature error” described above.

When an error occurs during the non-contact power supply performed by the power supplier and the occurring error corresponds to the power error, the notification controller 114 provides notification in a third manner at time of the retry processing and provides notification in a fourth manner at time of error confirmation. Each of the third manner and the fourth manner is a notification manner different from the first manner indicating that power supply is normal. Specifically, when the error determiner 112 determines that the power error occurs, the notification controller 114 flashes the LED of the notifier 16 in orange at time of the retry processing, and flashes the LED of the notifier 16 in red at time of error confirmation.

In this way, the notification controller 114 provides notification in the third manner being the notification manner different from that of (2) “during charging” described above at time of the retry processing for the power error. The reason is that, as described above, (B1) a position deviation of the robot 20, (B2) presence of foreign matter, and (B3) occurrence of an overcurrent or an overvoltage are conceivable as a cause of the power error, and there is a high possibility that a user needs to take action in order to solve the power error. Thus, when the power error occurs during the non-contact power supply performed on the robot 20 by the power supplier, the notification controller 114 immediately notifies the user without waiting for the error to be solved by the retry processing.

When the user receives such notification in the third manner, the user can take action for solving the error while the non-contact power supply is temporarily stopped in the retry processing. Action by the user is, for example, to correct a position deviation of the robot 20 when a position of the robot 20 deviates, to remove foreign matter when the foreign matter is present, and the like.

When the temperature error is solved by the retry processing, the notification controller 114 switches from the third manner to the first manner indicating that power supply is normal, and provides notification. In contrast, when the power error is not solved by the retry processing, the notification controller 114 switches to the fourth manner being the notification manner different from all of the first to third manners, and provides notification. In this way, the notification controller 114 emphasizes that the power error occurs, provides notification, and causes the user to recognize that further action for the power error is needed.

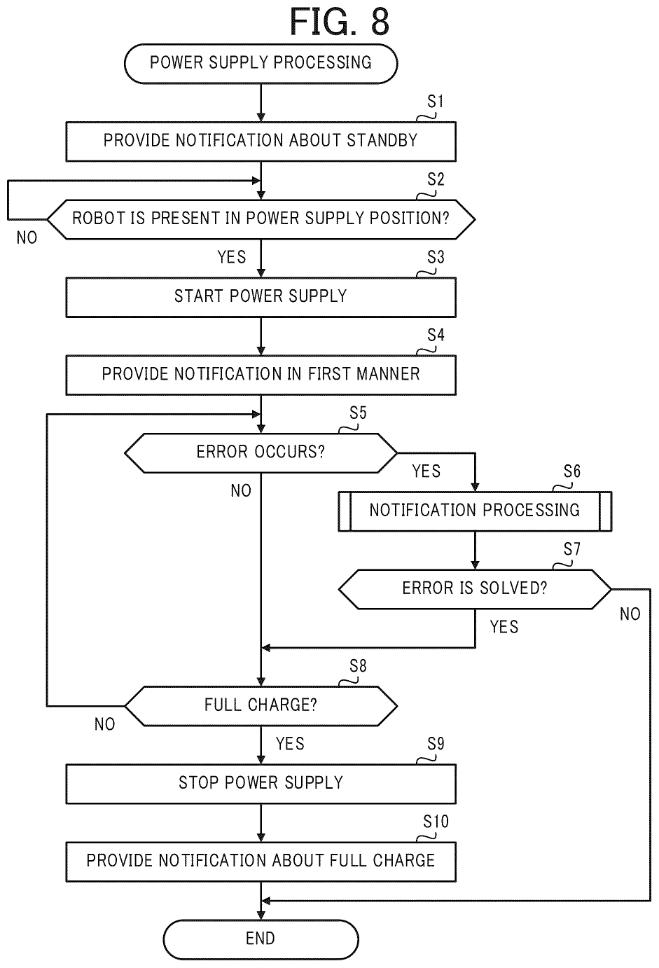

Next, with reference to FIG. 8, a flow of power supply processing executed by the power supply device 10 is described. The power supply processing illustrated in FIG. 8 is executed by the controller 110 of the control module 100 in a state where power is supplied from the AC adapter 17 to the power supply device 10 and the power supply device 10 can normally operate. The power supply processing illustrated in FIG. 8 is one example of a notification method.

When the power supply processing starts, the controller 110 provides notification that the power supply device 10 is in a standby state (step S1). Specifically, the controller 110 continuously lights the LED of the notifier 16 in white.

Next, the controller 110 determines whether the robot 20 is present in a power supply position (step S2). Specifically, when the controller 110 receives, via the communicator 130, notification that the robot 20 has moved to above the pedestal 18, the controller 110 determines that the robot 20 is present in the power supply position.

When the robot 20 is not present in the power supply position (step S2; NO), the controller 110 remains in step S2, and waits until the robot 20 moves to the power supply position.

When the robot 20 is present in the power supply position (step S2; YES), the controller 110 starts power supply to the robot 20 (step S3). Specifically, the controller 110 switches the switch 14 to ON, and starts supply of power to the power supplier (the transmission module 11 and the transmission antenna 12). In this way, an induced magnetic flux is generated from the transmission antenna 12, and the non-contact power supply starts.

When the power supply to the robot 20 starts, the controller 110 provides notification in a first manner indicating that the battery 24 is being charged (step S4). Specifically, the controller 110 continuously lights the LED of the notifier 16 in orange.

The controller 110 determines whether an error occurs during the power supply to the robot 20 (step S5). Specifically, the controller 110 acquires a sensor value measured by each of the thermistor 15, the current sensor 13, and the voltage sensor 25. Then, the controller 110 determines whether at least one of a temperature error being an error of a first classification and a power error being an error of a second classification occurs, based on the acquired sensor value.

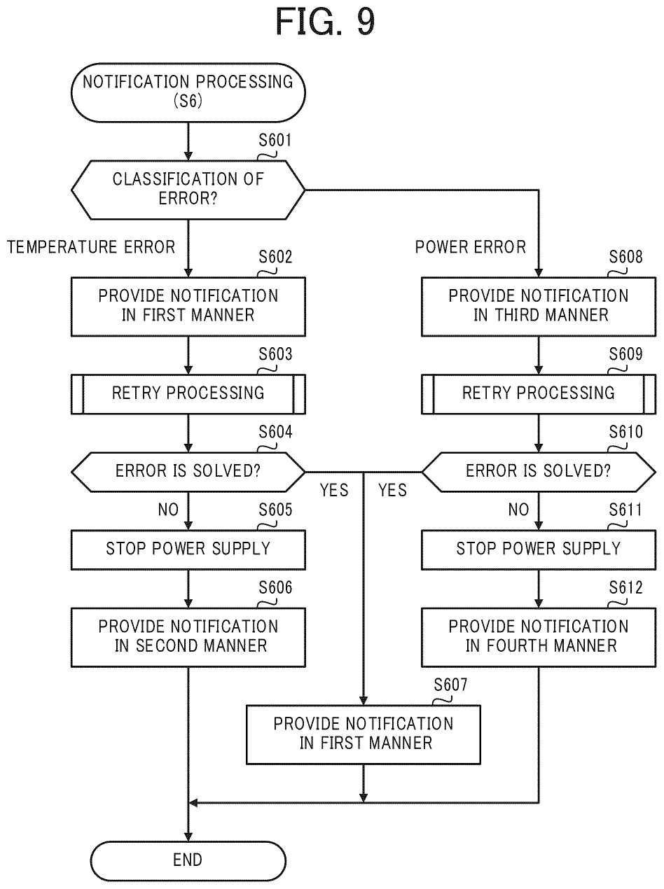

When the error occurs (step S5; YES), the controller 110 executes the notification processing (step S6). Details of the notification processing in step S6 are described with reference to FIG. 9.

When the notification processing illustrated in FIG. 9 starts, the controller 110 determines a classification of the occurring error (step S601). For example, when a temperature measured by the thermistor 15 does not fall within an appropriate temperature range, the controller 110 determines that the occurring error corresponds to the temperature error being the first classification. Alternatively, when a difference between transmission power and reception power derived based on the current sensor 13 and the voltage sensor 25 is equal to or more than a threshold value, the controller 110 determines that the occurring error corresponds to the power error being the second classification.

When the occurring error corresponds to the temperature error (step S601; temperature error), the controller 110 provides notification in the first manner (step S602). Specifically, the controller 110 continuously lights the LED of the notifier 16 in orange. In other words, the controller 110 continues notification in the same notification manner without changing the notification manner from “during charging” in step S4.

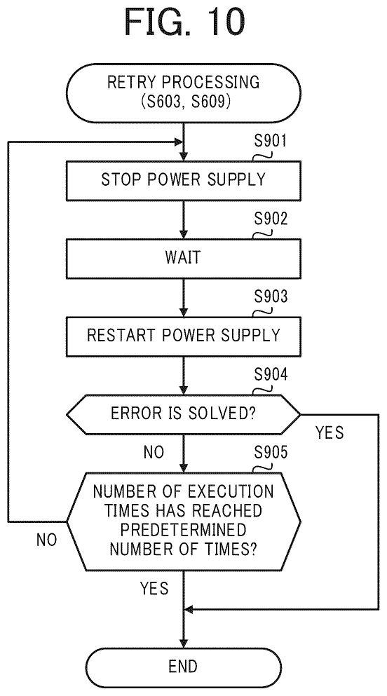

Next, the controller 110 executes retry processing (step S603). Details of the retry processing in step S603 are described with reference to FIG. 10.

When the retry processing illustrated in FIG. 10 starts, the controller 110 switches the switch 14 to OFF, and stops the power supply to the robot 20 (step S901). Then, the controller 110 waits for only a predetermined waiting time since the power supply is stopped (step S902). After a lapse of the waiting time since the power supply is stopped, the controller 110 switches the switch 14 to ON, and restarts the power supply to the robot 20 (step S903).

When the power supply restarts, the controller 110 determines whether the error is solved (step S904). Specifically, the controller 110 acquires a sensor value measured by each of the thermistor 15, the current sensor 13, and the voltage sensor 25. Then, the controller 110 determines that the error is solved when neither of the temperature error being the error of the first classification and the power error being the error of the second classification occurs, based on the acquired sensor value.

When the error is solved (step S904; YES), the controller 110 ends the retry processing illustrated in FIG. 10.

In contrast, when the error is not solved (step S904; NO), the controller 110 determines whether the number of execution times of the processing in steps S901 to S904 has reached a predetermined number of times (step S905). When the number of execution times has not reached the predetermined number of times (step S905; NO), the controller 110 returns the processing to step S901, and executes the processing in steps S901 to S904 again. In this way, the controller 110 repeats the processing in steps S901 to S904 for the predetermined number of times unless the error is solved at any point in time.

When the number of execution times has reached the predetermined number of times (step S905; YES), the controller 110 ends the retry processing illustrated in FIG. 10.

Returning to FIG. 9, when the retry processing is executed, the controller 110 determines whether the error is solved by the retry processing (step S604). A case where the error is solved corresponds to the case where the error is solved in step S904 of the retry processing. In contrast, a case where the error is not solved corresponds to the case where the number of execution times of the processing in steps S901 to S904 has reached the predetermined number of times in step S905 of the retry processing.

When the error is not solved (step S604; NO), the controller 110 switches the switch 14 to OFF, and stops the power supply to the robot 20 (step S605). Then, the controller 110 provides notification in a second manner different from the first manner (step S606). Specifically, the controller 110 flashes the LED of the notifier 16 while changing a color alternately between white and orange.

In contrast, when the error is solved (step S604; YES), the controller 110 provides notification in the first manner (step S607). Specifically, the controller 110 continuously lights the LED of the notifier 16 in orange. In other words, the controller 110 continues notification in the same notification manner without changing the notification manner from step S4 and step S602.

In step S601, when the occurring error corresponds to the power error (step S601; power error), the controller 110 provides notification in a third manner (step S608). Specifically, the controller 110 flashes the LED of the notifier 16 in orange.

Next, the controller 110 executes the retry processing (step S609). The retry processing in step S609 is the same as the retry processing in step S603 described with reference to FIG. 10, and thus the description is omitted.

When the retry processing is executed, the controller 110 determines whether the error is solved by the retry processing (step S610). When the error is not solved (step S610; NO), the controller 110 stops the power supply to the robot 20 (step S611), and provides notification in a fourth manner (step S612). Specifically, the controller 110 flashes the LED of the notifier 16 in red.

In contrast, when the error is solved (step S610; YES), the controller 110 shifts the processing to step S607, and provides notification in the first manner. Specifically, the controller 110 continuously lights the LED of the notifier 16 in orange, similarly to “during charging” in step S4. In this way, the controller 110 notifies a user that no error occurs. As described above, the notification processing illustrated in FIG. 9 ends.

Returning to FIG. 8, when the notification processing is executed, the controller 110 determines whether the error is solved by the notification processing in step S6 (step S7). A case where the error is solved corresponds to the case where the error is solved in step S604 or step S610 of the notification processing. In contrast, a case where the error is not solved corresponds to the case where the error is not solved in step S604 or step S610 of the notification processing.

When the error is not solved (step S7; NO), it is determined to be difficult to continue the power supply to the robot 20. Thus, in this case, the controller 110 ends the power supply processing illustrated in FIG. 8.

In contrast, when the error is solved (step S7; YES) and when the error does not occur in step S5 (step S5; NO), the controller 110 determines whether the battery 24 of the robot 20 has reached a full charge (step S8).

When the full charge has not been reached (step S8; NO), the controller 110 returns the processing to step S5. In this case, the controller 110 continues the power supply to the robot 20, and, when an error occurs during the power supply, the controller 110 executes the processing in steps S6 and S7.

When the full charge has been reached in the end (step S8; YES), the controller 110 transmits an OFF signal to the switch 14, and stops the power supply to the robot 20 (step S9). Then, the controller 110 continuously lights the LED of the notifier 16 in green, and provides notification that the power supply is completed (step S10). As described above, the power supply processing illustrated in FIG. 8 ends.

As described above, when an error occurs during the non-contact power supply performed on the robot 20, the power supply device 10 according to Embodiment 1 executes the retry processing of stopping and then restarting the non-contact power supply. Then, when the error does not occur during the non-contact power supply, the power supply device 10 according to Embodiment 1 provides notification in the first manner, and when an error occurs during the non-contact power supply and the error corresponds to the error of the first classification, the power supply device 10 provides notification in the first manner during execution of the retry processing.

In this way, even when the error of the first classification occurs, the power supply device 10 according to Embodiment 1 provides, during the retry processing, notification in the same notification manner as that in a normal condition where no error occurs. When an error that does not need to be immediately handled by a user occurs, the user does not immediately recognize the occurrence of the error, and is not thus bothered by action of turning on a power source of a device again, and the like. Thus, when an error occurs, the power supply device 10 according to Embodiment 1 can appropriately provide notification according to a classification of the error.

Further, when the error of the first classification is not solved even after execution of the retry processing, the power supply device 10 according to Embodiment 1 provides notification in the second manner different from the first manner. Furthermore, when an error occurs during the non-contact power supply and the error corresponds to the error of the second classification, the power supply device 10 according to Embodiment 1 provides notification in the third manner different from the first manner during execution of the retry processing.

In this way, when an error that does not need to be immediately handled by the user occurs, the power supply device 10 according to Embodiment 1 provides notification in a notification manner different from that in a normal condition at a timing at which the error needs to be handled by the user. On the other hand, when an error that needs to be immediately handled by the user occurs, the power supply device 10 according to Embodiment 1 immediately provides notification about the error. Thus, when an error occurs, the power supply device 10 according to Embodiment 1 can appropriately provide notification at a timing needed for the user.

### Embodiment 2

Next, Embodiment 2 is described. A description of a configuration and a function same as those in Embodiment 1 is omitted as appropriate.

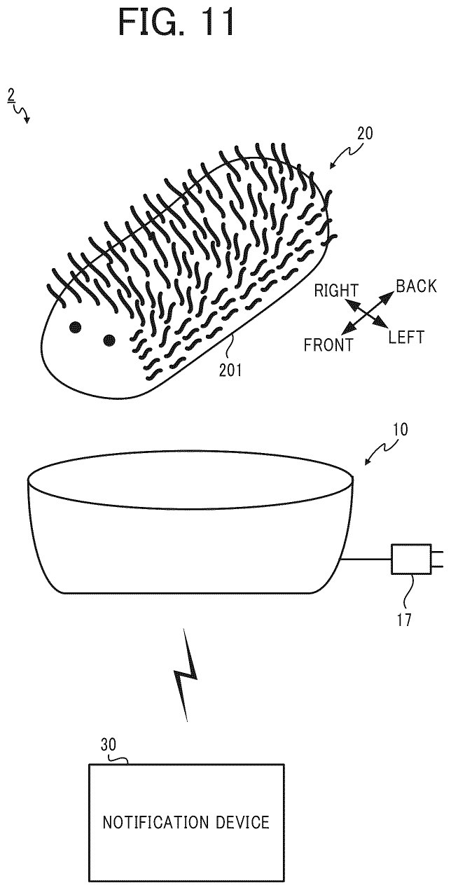

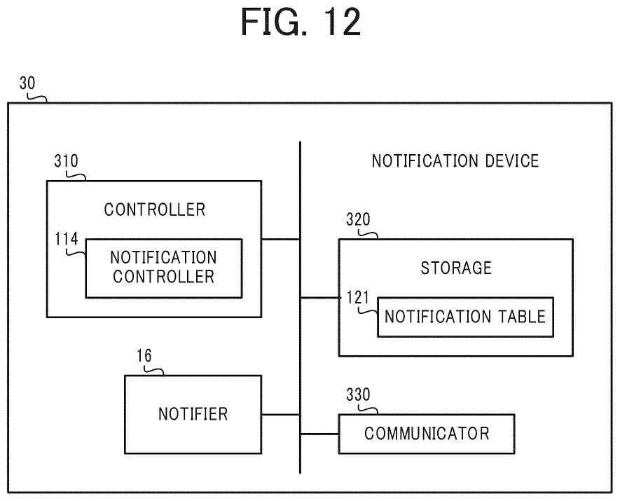

FIG. 11 illustrates a configuration of a power supply system 2 according to Embodiment 2. The power supply system 2 according to Embodiment 2 includes a power supply device 10, a robot 20, and a notification device 30. In Embodiment 1 described above, the notifier 16 and the notification controller 114 are included in the power supply device 10. In contrast, in Embodiment 2, a notifier 16 and a notification controller 114 are included in the notification device 30 being an external device of the power supply device 10.

The notification device 30 is a device that provides notification according to a state of the power supply device 10 being a target device. The notification device 30 may be a general-purpose information processing device such as a PC, a smartphone, a tablet terminal, and a wearable terminal, or may be a device specialized in a notification function.

As illustrated in FIG. 12, the notification device 30 includes the notifier 16, a controller 310, a storage 320, and a communicator 330. The controller 310 includes a CPU, and controls actions of the entire notification device 30. The storage 320 includes a ROM, a RAM, a flash memory, and the like. The communicator 330 includes a communication interface for communicating with the power supply device 10, and communicates with the power supply device 10 in a wired or wireless manner according to appropriate communication standards. Similarly to Embodiment 1, the power supply device 10 includes a power supply controller 111, an error determiner 112, and a retry processor 113.

In the notification device 30, the controller 310 functionally includes a notification controller 114. The notification controller 114 executes notification control processing similar to that of the notification controller 114 included in the power supply device 10 in Embodiment 1. Specifically, the notification controller 114 causes an LED of the notifier 16 to emit light in a notification manner determined in a notification table 121 stored in the storage 320.

More specifically, the notification controller 114 communicates with the power supply device 10 via the communicator 330, and acquires information indicating timings of a start and a stop of power supply by the power supply controller 111, an error determination result by the error determiner 112, and whether the retry processor 113 is executing retry processing. Then, the notification controller 114 causes the LED of the notifier 16 to emit light in a notification manner corresponding to a state during non-contact power supply being a predetermined action performed in the power supply device 10 being a target device.

For example, when an error does not occur during the non-contact power supply performed in the power supply device 10, the notification controller 114 provides notification in a first manner. Further, in a case where a temperature error occurs during the non-contact power supply performed in the power supply device 10, the notification controller 114 provides notification in the first manner when the power supply device 10 executes the retry processing, and provides notification in a second manner when the temperature error is not solved even after the retry processing is executed. Furthermore, in a case where a power error occurs during the non-contact power supply performed in the power supply device 10, the notification controller 114 provides notification in a third manner when the power supply device 10 executes the retry processing, and provides notification in a fourth manner when the power error is not solved even after the retry processing is executed.

In this way, the notification device 30 according to Embodiment 2 provides notification according to a state of the power supply device 10 being a target device. Since the notification device 30 being a device independent of the power supply device 10 has the notification function, a user can confirm a state of the power supply device 10 even if the notifier 16 and the notification controller 114 are not included in the power supply device 10 itself.

### Modified Examples

The embodiments of the present disclosure are described above, but the embodiments described above are examples, and an application range of the present disclosure is not limited thereto. In other words, various modifications are possible in the embodiments of the present disclosure, and every embodiment is included in the range of the present disclosure.

For example, in Embodiment 2 described above, the notification device 30 is a device separated from the power supply device 10 and the robot 20. However, the notification device 30 may be provided inside the robot 20. In other words, the robot 20 may include the notifier 16 and the notification controller 114, and provide notification according to a state of the power supply device 10.

In Embodiment 2 described above, the notification controller 30 provides notification according to a state during the non-contact power supply being a predetermined action performed in the power supply device 10 being a target device. However, a target device being a target for notification by the notification device 30 is not limited to the power supply device 10.

For example, the target device may be a general information processing device or a general communication device, or may be a driving device including a driving mechanism such as the robot 20. When the target device is a general information processing device or a general communication device, the predetermined action may not be non-contact power supply, and may be, for example, general information processing or general communication processing. When the target device is a driving device, the predetermined action may be an action of driving a driving mechanism.

The notification device 30 is not limited to a device separated from the target device, and may be provided inside the target device.

In the embodiments described above, the error of the first classification is the temperature error, and the error of the second classification is the power error. However, the errors of the first classification and the second classification are not limited thereto. The error of the first classification may be any error as long as the error is not an error that does not need to be immediately handled by a user, and the error of the second classification may be any error as long as the error is an error that needs to be handled by the user. For example, when the target device is a general information processing device or a general communication device, the errors of the first classification and the second classification may be errors related to general information processing or general communication processing. Alternatively, when the target device is a driving device, the errors of the first classification and the second classification may be errors related to driving of a driving mechanism.

In the embodiments described above, the notification controller 114 causes the LED of the notifier 16 to emit light in the notification manner determined in the notification table 121 illustrated in FIG. 7. However, the notification manner in the notification table 121 illustrated in FIG. 7 is one example, and which color and pattern the LED is lighted in can be freely set. For example, in the embodiments described above, the second to fourth manners are different from one another, but the manners are manners each indicating some sort of error, and thus at least two of the second to fourth manners may be the same as long as the manners are different from the first manner indicating that power supply is normal.

In the embodiments described above, the notifier 16 includes the LED, and the notification controller 114 provides notification by causing the LED to emit light in a color and a pattern corresponding to a state of the power supply device 10. However, the notifier 16 may include a display, a speaker, and the like instead of the LED. For example, the notification controller 114 may provide notification by displaying a display image corresponding to a state of the power supply device 10 on the display. Alternatively, the notification controller 114 may provide notification by outputting a sound corresponding to a state of the power supply device 10 from the speaker.

In the embodiments described above, the exterior 201 has a cylindrical shape from the head 204 to the torso 206, and the robot 20 has a shape that lies on a stomach. However, the robot 20 is not limited to resembling a living creature having a shape that lies on a stomach. For example, the robot 20 may resemble a quadruped or biped living creature having a shape with hand and foot.

In the embodiments described above, in the controller 110, the CPU functions as each component of the power supply controller 111, the error determiner 112, the retry processor 113, and the notification controller 114 by executing the program stored in the ROM. Further, in the controller 310, the CPU functions as the notification controller 114 by executing the program stored in the ROM. However, in the present disclosure, the controllers 110 and 310 may include, instead of the CPU, special-purpose hardware such as, for example, an application specific integrated circuit (ASIC), a field-programmable gate array (FPGA), or various control circuits, and the special-purpose hardware may function as each component of the power supply controller 111, the error determiner 112, the retry processor 113, and the notification controller 114. In this case, each function of each component may be achieved by an individual piece of the hardware, or functions of the components may be collectively achieved by a single piece of the hardware. A part of the functions of the components may be achieved by the special-purpose hardware, and the other part may be achieved by software or firmware.

Note that an existing information processing device and the like can be not only provided as a robot having, in advance, a configuration for achieving the functions according to the present disclosure, but can also function as the power supply device 10 and the notification device 30 according to the present disclosure by application of a program. In other words, a program for achieving each functional configuration by the power supply device 10 and the notification device 30 exemplified in the embodiments described above is applied in such a way that the CPU and the like for controlling an existing information processing device and the like can be executed, and thus the existing information processing device and the like can function as the robot according to the present disclosure.

Further, any method can be used to apply such programs. For example, the programs can be applied by storing the programs in a non-transitory computer-readable storage medium such as a flexible disc, a compact disc (CD)-ROM, a digital versatile disc (DVD)-ROM, and a memory card. Furthermore, the programs can be piggybacked on carrier waves and applied via a communication medium such as the Internet. For example, the programs may be posted on a bulletin board system (BBS) on a communication network, and be distributed. Then, the processing described above may be executed by starting the programs and, under the control of the operating system (OS), executing the programs in the same manner as other applications/programs.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A power supply system comprising:
an indicator lamp; and
at least one processor,
wherein the at least one processor
executes retry processing of stopping and then restarting non-contact power supply in a case where an error occurs during the non-contact power supply performed on a robot, and
maintains a display manner of the indicator lamp during execution of the retry processing as a first manner same as a manner when the error does not occur, in a case where a state of the non-contact power supply is notified by a display manner of the indicator lamp and the occurring error corresponds to an error of a first classification.

2. The power supply system according to claim 1, wherein the at least one processor switches a display manner of the indicator lamp to a second manner different from the first manner in a case where the error of the first classification is not solved by the retry processing.

3. The power supply system according to claim 1, wherein the at least one processor controls the indicator lamp in such a way that a display manner of the indicator lamp during execution of the retry processing is a third manner different from the first manner in a case where the occurring error corresponds to an error of a second classification.

4. The power supply system according to claim 3, wherein the at least one processor switches a display manner of the indicator lamp to a fourth manner different from the first manner and the third manner in a case where the error of the second classification is not solved by the retry processing.

5. The power supply system according to claim 2, wherein the at least one processor controls the indicator lamp in such a way that a display manner of the indicator lamp is the first manner in a case where the error is solved by the retry processing.

6. The power supply system according to claim 3, wherein the error of the first classification is an error related to a temperature in the non-contact power supply.

7. The power supply system according to claim 6, wherein the error of the second classification is an error based on a difference between transmission power and reception power in the non-contact power supply.

8. The power supply system according to claim 1, wherein the indicator lamp is provided on a power supply device that transmits power to the robot by the non-contact power supply, and is not provided on the robot that receives power.

9. The power supply system according to claim 8, wherein
the power supply device has an external shape in a bowl shape, and
the indicator lamp is provided on an outer surface side of the power supply device.

10. The power supply system according to claim 3, wherein
the first manner is a manner in which light continuously lights, and
the third manner is a manner in which light flashes and lights.

11. The power supply system according to claim 10, wherein
the first manner is a manner in which the same color is intermittently displayed, and
the second manner is a manner in which a display color regularly changes.

12. The power supply system according to claim 4, wherein a difference between the first manner and the fourth manner is a difference in a display color.

13. The power supply system according to claim 12, wherein
the third manner is a manner in which light flashes and lights, and
the fourth manner is a manner in which light continuously lights.

14. A notification method comprising:
executing retry processing of stopping and then restarting non-contact power supply in a case where an error occurs during the non-contact power supply performed on a robot; and
maintaining a display manner of an indicator lamp during execution of the retry processing as a first manner same as a manner when the error does not occur, in a case where a state of the non-contact power supply is notified by a display manner of the indicator lamp and the occurring error corresponds to an error of a first classification.

15. A non-transitory computer-readable storage medium storing a program, the program causing a computer to execute:
a function of executing retry processing of stopping and then restarting non-contact power supply in a case where an error occurs during the non-contact power supply performed on a robot; and
a function of maintaining a display manner of an indicator lamp during execution of the retry processing as a first manner same as a manner when the error does not occur, in a case where a state of the non-contact power supply is notified by a display manner of the indicator lamp and the occurring error corresponds to an error of a first classification.
